(19) United States
(12) Patent Application Publication
(10) Pub. No.: US 2007/0238469 A1
(43) Pub. Date: Oct. 11, 2007

(54) Radio Network Control Device, Radio Network Control Method, and Communication System

(75) Inventors: Yuichi Tsukamoto, Tokyo (JP); Hidenori Ishii, Tokyo (JP); Kenji Takagi, Kanagawa (JP)

Correspondence Address: RATNERPRESTIA, P.O. BOX 980, VALLEY FORGE, PA, 19482, US

(73) Assignee: MATSUSHITA ELECTRIC INDUSTRIAL CO., LTD., Osaka (JP)

(21) Appl. No.: 11/570,476

(22) PCT Filed: Dec. 1, 2005
(86) PCT No.: PCT/JP05/22070

§ 371 Date: Dec. 12, 2006

(30) Foreign Application Priority Data
Dec. 1, 2004 (JP) 2004-348101

(51) Int. Cl. H04Q 7/36

(52) U.S. Cl. 455/450

(57) ABSTRACT

A radio network controller which includes radio resource administration means for administrating a state of the use of radio resource, rack information administration means for administrating a state of the use of resource at base band signal processing unit in base transceiver station, and control means for selecting a call frequency used in base transceiver station and allocating it to a certain rack of base band signal processing unit. In the above configuration, a percentage of loss calls which occurred due to an insufficiency of empty amount with the radio resource, or of empty amount with the base band resource, can be lowered.

### TECHNICAL FIELD

The present invention relates to a device for controlling radio network, a method of controlling radio network and a communication system.

### BACKGROUND ART

Portable telephone service is now in its third generation stage. The communication speed has been increasing significantly, large volume contents such as music, moving pictures have become increasingly popular in addition to conventional still-pictures, text mails, etc. Many ways of services, such as a mixture of different speed data, a plurality of services offered simultaneously, a circuit-switched communication service, have already been introduced. Now, what is requested is a method with which the radio resource and the base band resource at base band signal processing unit of Base Transceiver Station (BTS) can be put into operation efficiently for packet-switched communication services.

In a conventional method of controlling the radio resource and the base band resource using a W-CDMA Radio Network Controller (RNC), the allocation of a call was made after looking into an amount of empty radio resource alone, or an amount of empty base band resource alone. Examples of such method have been disclosed in Japanese translation of PCT publication No. 2003-524335, Japanese Patent Unexamined Publication No. 2003-87854, “W-CDMA Mobile Communication” edited by Keiji Tachikawa, p 202-207, published by Maruzen Jun. 25, 2001, etc. A conventional method of controlling the radio resource and the base band resource with a W-CDMA radio network controller is described below referring to FIG. 21 through FIG. 28.

The radio resource is those resources in a wireless region between a BTS and the terminal. Examples of the radio resource include modulation code, transmitting power, amount of interference, etc. A radio resource amount needed for a BTS to receive a call is variable depending on a distance from BTS to a terminal and other factors; so, even among the calls of same channel type the radio resource amount is not always the same. The base band resource is a processing capacity available at base band signal processing unit of a BTS; which resource is needed for a hardware to diffuse and modulate a call. Base band resource needed for a BTS to receive a call has been determined by each call type.

FIG. 28 is a block diagram disclosed in the above-described Japanese Patent Unexamined Publication No. 2003-87854 and “W-CDMA Mobile Communication”, used to show a conventional communication system.

Referring to FIG. 28, a conventional communication system includes radio network controller 2301 coupled with core network 2302 and BTS 2307. Radio network controller 2301 and BTS 2307 are wire-connected. Core network 2302 is a large capacity trunk communication facility owned by a communication enterprise.

Radio network controller 2301 is for controlling the BTS, controlling the connection of transmitting/receiving, controlling the hang up, controlling the diversity hand over, etc. The controller includes wire communication means 2303 at the core network side, wire communication means 2304 at the BTS side, radio resource administration means 2305 and control means 2306.

Wire communication means 2303 at the core network side transmits/receives signal to and from core network 2302. Wire communication means 2304 at the BTS side transmits/receives signal to and from BTS 2307. Radio resource administration means 2305 administrates the utilization of radio resource. Control means 2306 controls all the operation performed by radio network controller 2301.

BTS 2307 is for radio communication with terminal 2308, which converts radio signals into wire signal for a wired network. Here, BTS 2307 splits a covering area into small sectors (sectorizing) by frequency; thereby the frequency can be used efficiently.

BTS 2307 includes wire communication means 2309, radio communication means 2310, base band signal processing unit 2311 and base band resource control means 2314.

Radio communication means 2310 is provided with an antenna, an amplifier, a power supply and a control program, and transmits/receives radio signals to and from terminal 2308. Radio communication means 2310 corresponds to respective sectors; so, number of which means varies along with a number of sectors.

Base band signal processing unit 2311 is for processing signals from terminal 2308; e.g. code modulation, conversion into wire signal, etc. The processing unit is formed of a plurality of circuit boards (cards) consisting of a plurality of ICs, connected together into the shape of a rack. Base band signal processing unit 2311 can process calls of one or more number of frequencies. The processing unit 2311 is split into first base band signal processing means 2312 and second base band signal processing means 2313 in order to increase the speed of diffusion processing and modulation processing, as well as to divide a processing load. Hereinafter, first base band signal processing means 2312 and second base band signal processing means 2313 are referred to as rack 1 and rack 2, respectively. Base band signal processing unit 2311 processes the signals in each frequency. If each of first base band signal processing means 2312 and second base band signal processing means 2313 is to control more number of frequencies, the processing load increases. Therefore, base band signal processing unit 2311 is restricted in the number of controllable frequencies, in view of the cost reduction and the processing load reduction.

Base band resource control means 2314 controls the empty resource amount in base band signal processing unit 2311. The control means allocates a call to a certain rack of base band signal processing unit 2311. The allocation of a call means an operation, upon arising of a call, to receive the call in a certain rack. The empty resource amount means a processing capacity left for new processing.

Now, a conventional procedure from the moment when a BTS is started until a call is allocated to BTS is described referring to FIGS. 21A, B, C and D.

Reference is made to FIG. 21A; when BTS 2307 is started, it transmits a message of initial registration request 1601 to radio network controller 2301, to have BTS 2307 registered. The 3GPP TS (Technical Specifications) 25. 433 Ver6. 0. 0 refers this message as AUDIT REQUIRED.

Upon receiving initial registration request 1601, radio network controller 2301 transmits a message of initialization processing request 1602 to BTS 2307. Upon receipt of the request, BTS 2307 transmits a message of initialization processing response 1603 to radio network controller 2301. The message contains, for example as FIG. 21B shows, a message type which indicates that the transmitting message is initialization processing response, and a local cell information which includes an identifier of a cell covered by BTS 2307. After the exchange of these messages, BTS 2307 and radio network controller 2301 finishes the initialization processing. This message of initialization processing response 1603 is referred to as AUDIT RESPONSE in 3GPP TS 25. 433 Ver6. 0. 0.

Then, when a call arises, the core network transmits a message 1604 to radio network controller 2301 requesting the allocation.

Radio network controller 2301 allocates the call to a radio resource.

And then, radio network controller 2301 transmits a message of allocation request 1605 (RADIO LINK SETUP REQUEST, in 3GPP TS 25. 433 Ver6. 0. 0) to BTS 2307. The transmitting message includes, for example as FIG. 21C shows, a message type which indicates that the transmitting message is the allocation request, and a transaction ID which is an identifier indicating a procedure for each message between BTS 2307 and radio network controller 2301. Upon receiving the message, BTS 2307 allocates a call to a rack.

When the allocation is finished, BTS 2307 transmits a message of allocation response 1606 (RADIO LINK SETUP RESPONSE, in 3GPP TS 25. 433 Ver6. 0. 0). The transmitting message contains, for example as FIG. 21D shows, a message type indicating that it is the allocation response, and a scrambling code for identification of a terminal.

Now in the following, description is made on a conventional resource control for allocating a call to a radio resource in radio network controller.

Radio network controller 2301 calculates the amount of radio resource used at each frequency based on such parameters as transmitting speed, transmitting power, etc. The amount of radio resource used is expressed in terms of processing capacity (kbps). Every time when a call arises, radio network controller 2301 calculates an amount of radio resource required for the call, and allocates the call to a certain frequency which can house the required resource amount.

Then, radio network controller 2301 requests BTS 2307 to allocate a call, BTS 2307 allocate the call to a most suitable base band signal processing means. The transmitting power increases along with an increasing distance of terminal from BTS; likewise, the amount of radio resource increases proportionate to a distance from BTS. Therefore, calls can bear different radio resource amount and base band resource amount used.

Now in the following, the procedures how radio network controller 2301 allocates a call to a radio resource frequency and BTS 3207 allocates the call to a base band resource are described using a practical example.

FIG. 22 shows area 1709 covered by BTS 2307, and terminals 1705 through 1708 placed within area 1709. Here, it is presumed that distances 1701-1704 from BTS 2307 to respective terminals 1705-1708 have following relationship:
Distance 1701=Distance 1702<Distance 1703<Distance 1704

Suppose terminal 1705 and terminal 1706 shown in FIG. 22 are having a packet call each.

FIG. 23 shows particulars of these packet calls.

Packet calls 1801 and 1802 in Nos. 1 and 2 are those made to terminals 1705 and 1706, respectively. Both of the packet calls have frequency f1, radio resource amount 128 kbps, base band resource amount 384 kbps.

How radio network controller 2301 allocates packet call 1801 to a radio resource frequency is described first. Status quo of radio resource and base band resource used is as shown in FIGS. 24A and B.

In FIGS. 24A and B, a unit frame in the illustration represents the resource amount 128 kbps, for both the radio resource and the base band resource. The maximum amount of radio resource at each frequency is 1024 kbps, the greatest amount of base band resource at each rack is 1792 kbps. Whereas the radio resource amount needed by packet call 1801 is 128 kbps, an amount of empty resource 1901a available at frequency f1 is 640 kbps (=1024 kbps−384 kbps); therefore, packet call 1801 can be allocated to there.

How BTS 2307 allocates packet call 1801 to a base band resource is described below.

Whereas the amount of base band resource needed by packet call 1801 is 384 kbps, an amount of empty resource 1901b available at rack 1 is as ample as 896 kbps; therefore, the base band resource 384 kbps needed by packet call 1801 can be allocated to rack 1. An amount of base band resource required for placing a call in BTS has already been determined for each of the call types.

Packet call 1801 is thus allocated. Position of the radio resource and the base band resource after the allocation is as shown in FIGS. 25A and B.

Packet call 1802 is allocated in the same manner as packet call 1801. FIGS. 26A and B show position of the radio resource and the base band resource after allocation of packet call 1802.

Now, suppose packet calls 1803 and 1804 have arisen to terminals 1707 and 1708, respectively, ref. FIG. 22.

Allocation of packet call 1803 to a radio resource is described first.

As shown in FIG. 23 at No. 3, packet call 1803 has frequency f3, radio resource amount 384 kbps, base band resource amount 128 kbps.

Whereas packet call 1803 needs radio resource 384 kbps, an amount of empty resource 2101a available is 512 kbps as shown in FIG. 26A; therefore, packet call 1803's radio resource amount 384 kbps can be allocated to there.

Then, allocation of packet call 1803 to a base band resource is described.

Whereas packet call 1803 needs base band resource 128 kbps, an amount of empty resource 2101b available at rack 2 is 896 kbps as show in FIG. 26B; therefore, packet call 1803's base band resource amount 128 kbps can be allocated to rack 2. FIGS. 27A and B show position of the radio resource and the base band resource after the allocation of packet call 1803.

Next, allocation of packet call 1804 to radio resource is described.

As shown in FIG. 23 at No. 4, packet call 1804 has frequency f3, radio resource amount 256 kbps, base band resource amount 384 kbps.

The amount of empty radio resource 2201a available at frequency f3, however, is only 128 kbps as shown in FIG. 27A.

Thus, the amount of empty radio resource 2201a at frequency f3 is in short; so, radio network controller 2301 can not allocate packet call 1804. Meanwhile, since frequency f4 has already been using the entire resource, radio network controller 2301 is unable to switch the allocated frequency f3 to f4.

As FIG. 27A shows, the amount of empty radio resource 2201b at frequency f1 is 384 kbps. It appears as if it is possible to allocate packet call 1804's radio resource 256 kbps to there. However, as FIG. 27B shows, amount of empty resource 2201c available at rack 1 for receiving frequency f1 as base band resource is only 128 kbps; so, packet call 1804's base band resource 384 kbps can not be allocated to there. Even if the frequency was switched to f1, packet call 1804 is rendered to become a loss call.

As described in the above, in allocating a call, a conventional technology looks into the amount of empty radio resource alone, even when a radio resource amount of the call is different from a base band resource amount. Therefore, some of calls were sometimes rendered to become loss calls despite there is a sufficient amount of empty resource available in the radio resource, or in the base band resource. This has remained as an outstanding problem to be solved.

### SUMMARY OF THE INVENTION

The present invention offers a radio network controller, a method of controlling radio network and a communication system, with which a percentage of loss calls which occurred due to either an insufficient amount of empty radio resource, or an insufficient amount of empty base band resource, can be lowered.

A radio network controller in the present invention includes a radio resource administration means for administrating a state of the use of radio resource, which radio resource being a resource in a radio region between a BTS and a terminal; a rack information administration means for administrating a state of the use of a plurality of racks, which racks constituting the resource of BTS's base band signal processing means; and a control means for selecting a call frequency used in BTS and allocating it to a rack of base band signal processing means, based on the state of the use of the radio resource and the state of the use of the resource at base band processing means.

In the above configuration, a percentage of loss calls which would occur at the allocation of a call to a radio resource due to either an insufficiency of the empty base band resource amount despite there is a sufficient empty radio resource amount, or an insufficiency of the empty radio resource amount despite there is a sufficient empty base band resource amount, can be lowered.

A control means in radio network controller in accordance with the present invention transmits a message to BTS requesting to allocate a call to a specified base band signal processing means.

In the above configuration, radio network controller can send a message to a specified base band signal processing means of BTS requesting an allocation.

The state of the use of resource at base band signal processing means of BTS, which is under the administration of radio network controller in accordance with the present invention, is an information which contains a number of counts of base band signal processing means in BTS, a number of frequencies controllable at each base band signal processing means and the greatest amount of resource at each base band signal processing means.

With the structure described in the above, an amount of empty resource in each rack of BTS can be looked into when a BTS is started and a call is allocated to a radio resource.

The state of the use of resource at base band signal processing means of BTS, which is under the administration of radio network controller in accordance with the present invention, is an information which contains frequency determined for each base band signal processing means of BTS and a remaining process capacity at each base band signal processing means.

With the structure described in the above, an amount of empty resource in each rack of BTS can be looked into when a call is allocated to a radio resource.

A communication system in the present invention includes a radio network controller in accordance with the present invention, and a BTS which is wire-connected with the radio network controller and the base band resource is formed of a plurality of racks.

Under the above configuration, a percentage of loss calls which would occur due to either an insufficiency of empty base band resource amount despite there is a sufficient empty resource amount at the radio resource, or an insufficiency of empty radio resource amount despite there is a sufficient empty resource amount at the base band resource, can be lowered.

A method of controlling radio network in accordance with the present invention is for controlling the allocation of a call to a certain frequency for use in communication between a BTS and the terminal and the allocation of a base band resource of the BTS. The control method includes the steps of ; when a call arises, calculating an amount of radio resource used at a certain frequency allocated to the call, which radio resource being a wireless resource housed in a radio region between BTS and the terminal; calculating an amount of base band resource used at the allocated frequency; calculating an empty radio resource amount available at each frequency by deducting the radio resource amount used from empty radio resource amount at the time; calculating an empty base band resource amount available at each rack, which rack being the base band resource of a BTS coupled with radio network, by deducting the base band resource amount used from empty base band resource amount at the time; setting a priority order in accordance with the empty radio resource amount in each frequency; setting a priority order in accordance with the empty base band resource amount in each rack; and selecting a frequency-rack combination in which a product of the priority order set according to empty radio resource amount in each frequency by the priority order set according to empty base band resource amount in each rack makes the greatest.

A method of controlling radio network in accordance with the present invention is for controlling the allocation of a call to a certain frequency for use in communication between a BTS and the terminal and the allocation of a base band resource of the BTS. The control method includes the steps of ; when a call arises, calculating an amount of radio resource used at a certain frequency allocated to the call, which radio resource being a wireless resource housed in a radio region between BTS and the terminal; calculating an amount of base band resource used in the allocated frequency; calculating an empty radio resource amount available in each frequency by deducting the radio resource amount used from the empty radio resource amount at the time; calculating an empty base band resource amount available in each rack, which rack being the base band resource of a BTS coupled with radio network, by deducting the base band resource amount from the empty base band resource amount at the time; calculating a ratio of empty radio resource amount to the maximum radio resource amount in a region between BTS and the terminal; calculating a ratio of empty base band resource amount to the greatest base band resource amount in each rack of BTS; and selecting a frequency-rack combination in which a product of the ratio of empty radio resource amount in each frequency by the ratio of empty base band resource amount in each rack makes the greatest.

In the above described configuration, a percentage of loss calls which occurred at the allocation of a call to a radio resource due to either an insufficiency of empty base band resource amount despite there is a sufficient empty resource amount at the radio resource, or an insufficiency of empty radio resource amount despite there is a sufficient empty resource amount at the base band resource, can be lowered.

A percentage of loss calls can be reduced by a method in accordance with the present invention in which the amount of empty radio resource and the amount of empty base band resource are kept in a good balance in the course of the call allocation.

Thus, a radio network controller, a method of controlling radio network and a communication system in accordance with the present invention make it possible to improve the efficiency of housing the calls (allocation). As the result, a BTS will be able to process the calls with hardware resource of a smaller-scale in the base band signal processing unit. This leads to a cost advantage.

### BRIEF DESCRIPTION OF THE DRAWINGS

FIG. 1 is a block diagram showing a radio network controller and a BTS in accordance with a first exemplary embodiment of the present invention.

FIG. 2A is a sequence diagram showing the control between radio network controller and BTS in the first embodiment.

FIG. 2B is a diagram showing the message type used in the control between radio network controller and BTS in the first embodiment.

FIG. 2C is a diagram showing the message type used in the control between radio network controller and BTS in the first embodiment.

FIG. 2D is a diagram showing the message type used in the control between radio network controller and BTS in the first embodiment.

FIG. 3 is a processing flow chart of a radio network controller in the first embodiment.

FIG. 4 is a processing flow chart of a radio network controller in the first embodiment.

FIG. 5 is an illustration of an area of BTS and the terminals in the area.

FIG. 6 is a table of information about packet calls in the radio network controller in the first embodiment.

FIG. 7A is a chart showing the amount of radio resource used at each frequency, in a radio network controller in the first embodiment.

FIG. 7B is a chart showing the amount of base band resource used at each rack, which is under the administration of a radio network controller in the first embodiment.

FIG. 8A is a table showing the priority order of frequencies, in a radio network controller in accordance with the first embodiment.

FIG. 8B is a table showing the priority order of racks, in a radio network controller in the first embodiment.

FIG. 8C is a table used to describe a relationship between the priority order of frequencies and that of racks, in a radio network controller in the first embodiment.

FIG. 9A is a chart showing the amount of radio resource used at each frequency, in a radio network controller in the first embodiment.

FIG. 9B is a chart showing the amount of base band resource used at each rack, which is under the administration of a radio network controller in the first embodiment.

FIG. 10A is a table showing the priority order of frequencies, in a radio network controller in accordance with the first embodiment.

FIG. 10B is a table showing the priority order of racks, in a radio network controller in the first embodiment.

FIG. 10C is a table used to describe a relationship between the priority order of frequencies and that of racks, in a radio network controller in the first embodiment.

FIG. 11A is a chart showing the amount of radio resource used at each frequency, in a radio network controller in the first embodiment.

FIG. 11B is a chart showing the amount of base band resource used at each rack, which is under the administration of a radio network controller in the first embodiment.

FIG. 12A is a table showing the priority order of frequencies, in a radio network controller in accordance with the first embodiment.

FIG. 12B is a table showing the priority order of racks, in a radio network controller in the first embodiment.

FIG. 12C is a table used to describe a relationship between the priority order of frequencies and that of racks, in a radio network controller in the first embodiment.

FIG. 13A is a chart showing the amount of radio resource used at each frequency, in a radio network controller in the first embodiment.

FIG. 13B is a chart showing the amount of base band resource used at each rack, which is under the administration of a radio network controller in the first embodiment.

FIG. 14A is a table showing the priority order of frequencies, in a radio network controller in accordance with the first embodiment.

FIG. 14B is a table showing the priority order of racks, in a radio network controller in the first embodiment.

FIG. 14C is a table used to describe a relationship between the priority order of frequencies and that of racks, in a radio network controller in the first embodiment.

FIG. 15A is a chart showing the amount of radio resource used at each frequency, in a radio network controller in the first embodiment.

FIG. 15B is a chart showing the amount of base band resource used at each rack, which is under the administration of a radio network controller in the first embodiment.

FIG. 16 is a processing flow chart of a radio network controller in accordance with a second embodiment of the present invention.

FIG. 17A is a table showing the priority order of frequencies, in a radio network controller in accordance with the second embodiment.

FIG. 17B is a table showing the priority order of racks, in a radio network controller in the second embodiment.

FIG. 17C is a table used to describe a relationship between the priority order of frequencies and that of racks, in a radio network controller in the second embodiment.

FIG. 18A is a table showing the priority order of frequencies, in a radio network controller in the second embodiment.

FIG. 18B is a table showing the priority order of racks, in a radio network controller in the second embodiment.

FIG. 18C is a table used to describe a relationship between the priority order of frequencies and that of racks, in a radio network controller in the second embodiment.

FIG. 19A is a table showing the priority order of frequencies, in a radio network controller in the second embodiment.

FIG. 19B is a table showing the priority order of racks, in a radio network controller in the second embodiment.

FIG. 19C is a table used to describe a relationship between the priority order of frequencies and that of racks, in a radio network controller in the second embodiment.

FIG. 20A is a table showing the priority order of frequencies, in a radio network controller in the second embodiment.

FIG. 20B is a table showing the priority order of racks, in a radio network controller in the second embodiment.

FIG. 20C is a table used to describe a relationship between the priority order of frequencies and that of racks, in a radio network controller in the second embodiment.

FIG. 21A is a sequence diagram showing the control between a conventional radio network controller and a BTS.

FIG. 21B is a diagram showing the message type used in the control between a conventional radio network controller and a BTS.

FIG. 21C is a diagram showing the message type used in the control between a conventional radio network controller and a BTS.

FIG. 21D is a diagram showing the message type used in the control between a conventional radio network controller and a BTS.

FIG. 22 is a conventional illustration of an area of BTS, and the terminals in the area.

FIG. 23 is a table of packet calls in a conventional radio network controller.

FIG. 24A is a chart showing the amount of radio resource used at each frequency, in a conventional radio network controller.

FIG. 24B is a chart showing the amount of base band resource used at each rack, which is under the administration of a conventional radio network controller.

FIG. 25A is a chart showing the amount of radio resource used at each frequency, in a conventional radio network controller.

FIG. 25B is a chart showing the amount of base band resource used at each rack, which is under the administration of a conventional radio network controller.

FIG. 26A is a chart showing the amount of radio resource used at each frequency, in a conventional radio network controller.

FIG. 26B is a chart showing the amount of base band resource used at each rack, which is under the administration of a conventional radio network controller.

FIG. 27A is a chart showing the amount of radio resource used at each frequency, in a conventional radio network controller.

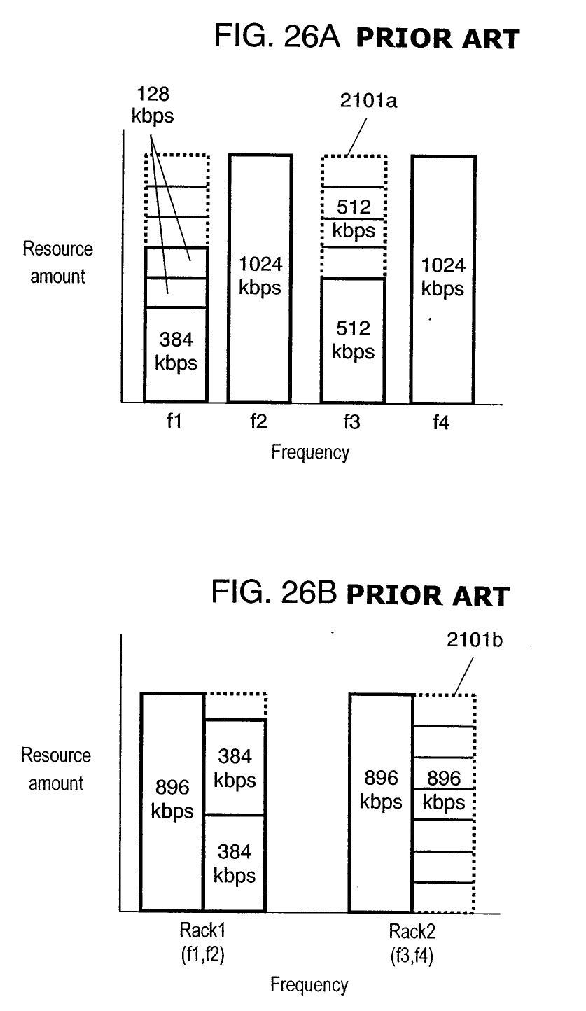

FIG. 26B is a chart showing the amount of base band resource used at each rack, which is under the administration of a conventional radio network controller.

FIG. 28 is a block diagram showing a conventional radio network controller and BTS.

### REFERENCE MARKS IN THE DRAWINGS

100 Radio Network Controller
101 Rack Information Administration Means
102 Core Network
103 Wire Communication Means at Core Network Side
104 Wire Communication Means at BTS Side
105 Radio Resource Administration Means
106 Control Means
107 Base Transceiver Station (BTS)
108 Terminal
109 Wire Communication Means
110 Radio Communication Means
111 Base Band Signal Processing Unit
112 First Base Band Signal Processing Means (Rack 1)
113 Second Base Band Signal Processing Means (Rack 2)
114 Base Band Resource Control Means
201 Initial Registration Request
202 Initialization Processing Request
203 Initialization Processing Response
204 Allocation Request from Core Network
205 Allocation Request
206 Allocation Response

### DETAILED DESCRIPTION OF PREFERRED EMBODIMENTS

### First Exemplary Embodiment

The present embodiment offers a method of providing a balance in the empty resource amount between the radio resource and the base band resource. Namely, the method tries to make best efforts so that there are as much empty resource amount provided at both of the radio resource and the base band resource, in the course of a call allocation operation. Describing more practically, every time when a new call arises, empty radio resource amount available at each frequency of carrier wave is ranked in the order of greatness, the rack of BTS is ranked in the order of empty base band resource, and a call is allocated to a certain combination of carrier wave frequency and BTS rack in which a specific relationship is established. In the first embodiment, a call is allocated to such a frequency-rack combination in which a product of the carrier wave frequency rank by the BTS rack rank makes the smallest.

In the following, the present embodiment is described referring to the drawings.

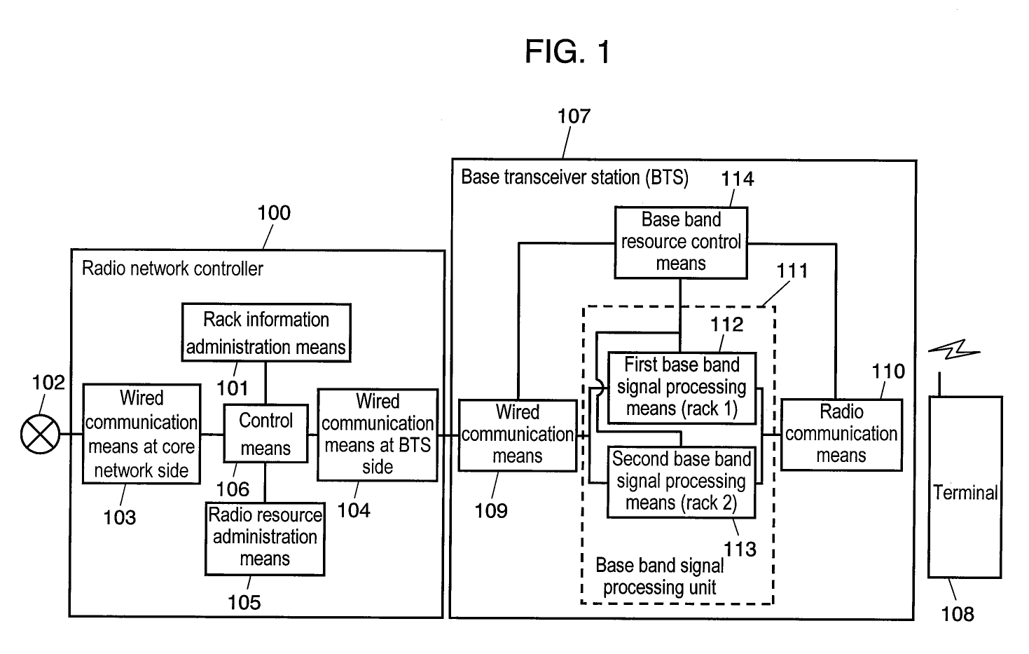

FIG. 1 is a block diagram of a communication system in accordance with an exemplary embodiment of the present invention. The point of difference as compared with a conventional communication system shown in FIG. 28 is that radio network controller 100 in the present embodiment is provided with rack information administration means 101 for administrating the racks as the base band resource of BTS 107. Therefore, control means 106 controls the operation of base band allocation in BTS 107, in addition to the operation of radio resource allocation.

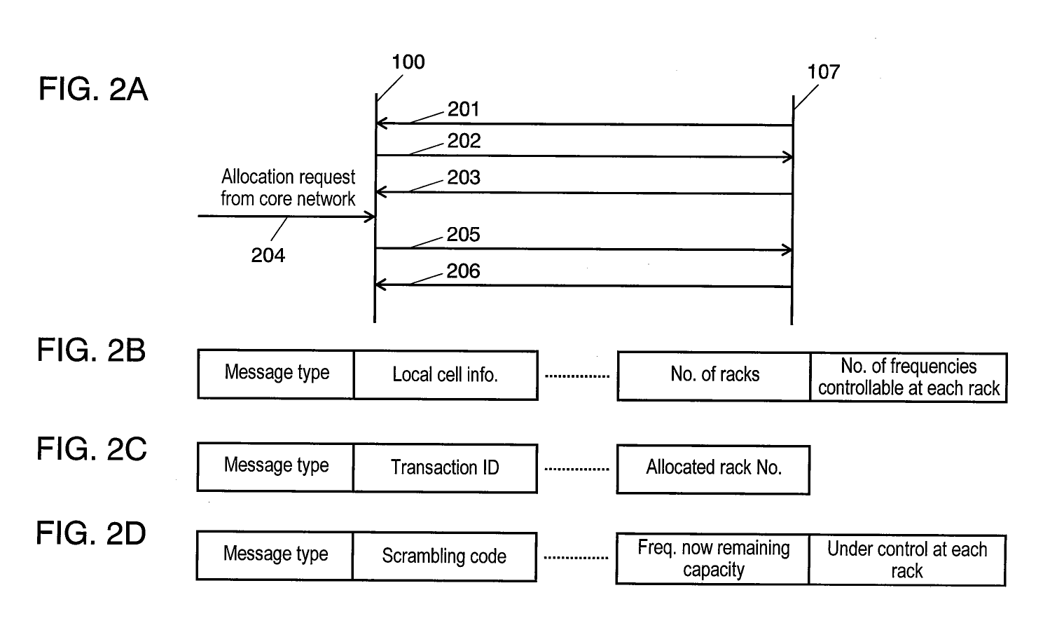

A series of procedures in the present invention from the moment when a BTS is started until a call is allocated to BTS is described referring to the sequence diagram, FIGS. 2A through D.

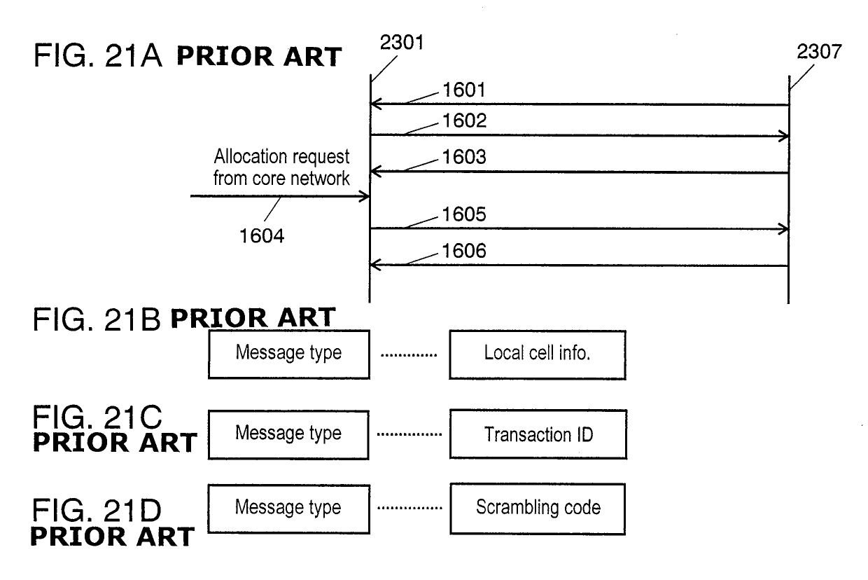

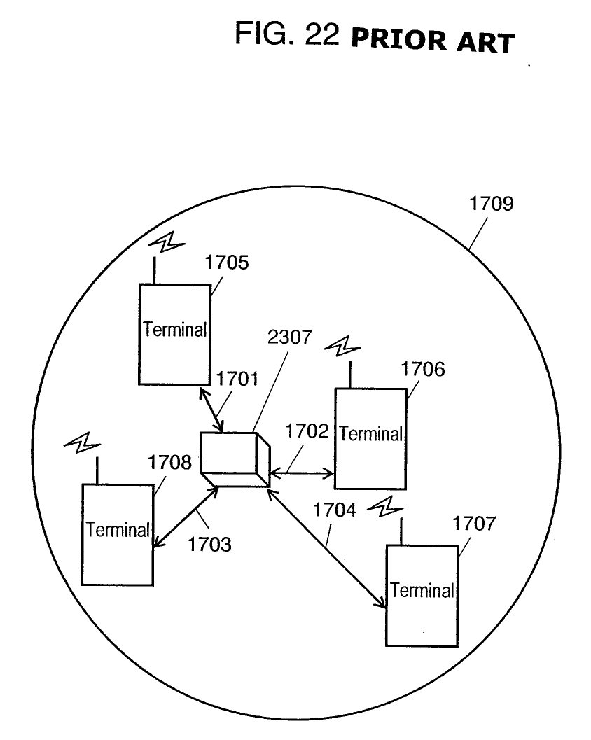

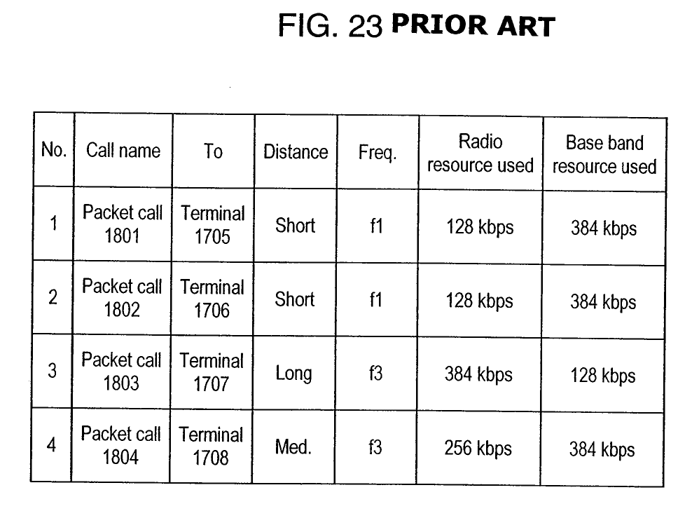

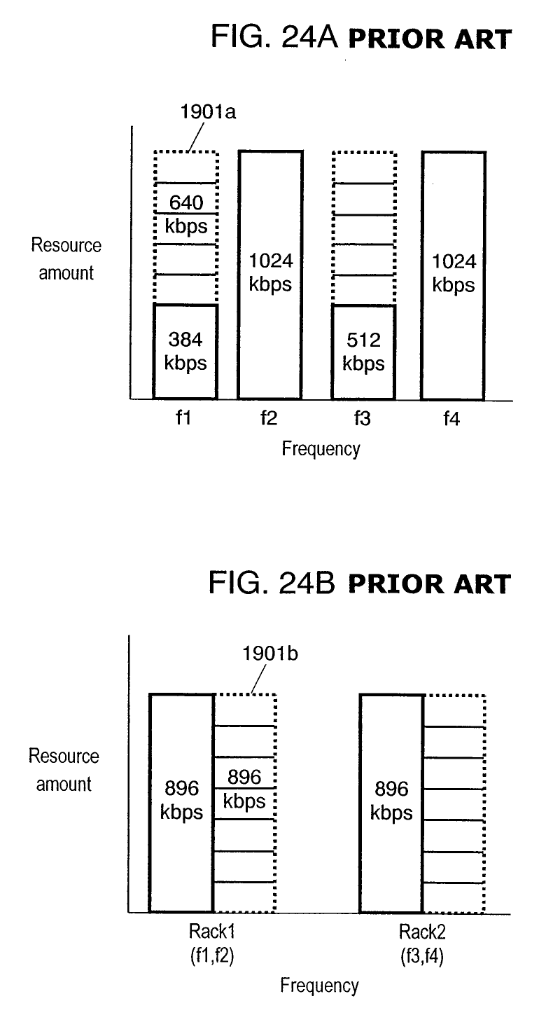

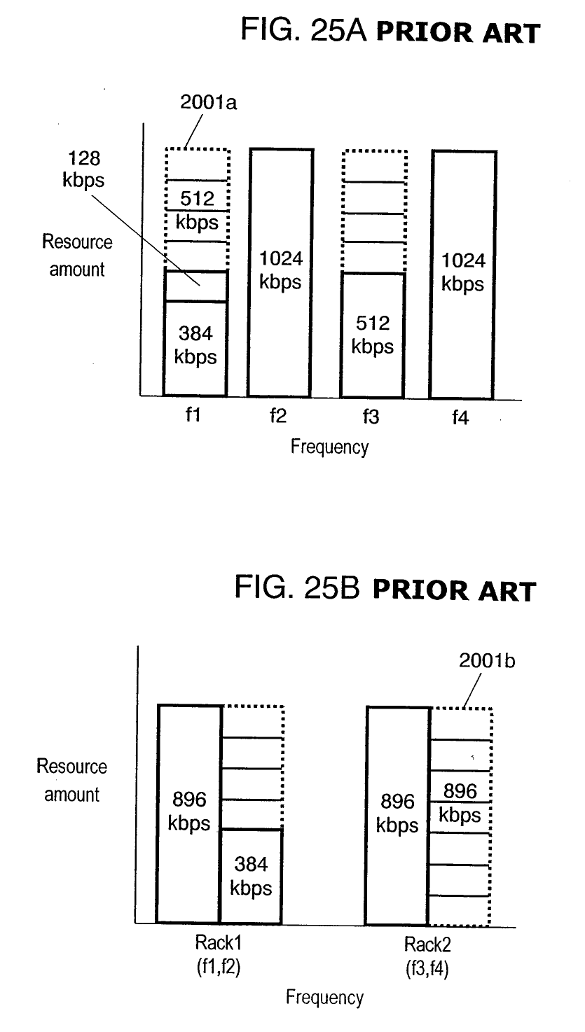

Referring to FIG. 2A, initializing processes 201 through 203 executed between radio network controller 100 and BTS 107 remain the same as those shown in FIG. 21A; however, the data structure of respective messages is different. Namely, as shown in FIG. 2B, initialization processing response 203 includes those messages: a message type indicating that the transmitting message is the initialization processing response, a local cell information which contains a cell identifier indicating that the cell is in the area covered by BTS 107, as well as a number of racks, the greatest processing capacity of each rack (number of call channels a rack can process) and a number of frequency kinds each rack can control, which being information administered by rack information administration means 101 used by radio network controller 100 when it looks into empty resource amount in each rack of BTS 107 for allocating a call to a certain radio resource.

When a new call arises, core network 102 transmits a message 204 to radio network controller 100 asking for an allocation.

Radio network controller 100 allocates the call to a radio resource. At the same time, a certain base band resource rack of BTS 107 is also determined. Algorithm of allocating a call to a radio resource and algorithm of deciding a rack allocation are described later.

Radio network controller 100 transmits a message of allocation request 205 to BTS 107, specifying a rack place. The transmitting message includes, for example as FIG. 2C shows, a message type indicating that the present message is allocation request, a transaction ID which is an identifier indicating a procedure conducted for each message between BTS 107 and radio network controller 100, and a rack number specified by radio network controller 100 when it allocated a call to radio resource. Upon receiving the message, BTS 107 allocates a call to the rack of specified number. The allocation request message 205 is referred to as RADIO LINK SETUP REQUEST in 3GPP TS 25. 433 Ver6. 0. 0.

When the allocating operation is completed, BTS 107 transmits a message of allocation response 206. The transmitting message contains, e.g. as FIG. 2D shows, a message type indicating that it is the allocation response, a scrambling code for identifying a terminal, as well as a frequency under control at that time in each rack and processing capacity remaining in each rack, which being information used by radio network controller 100 when it looks into the empty resource amount in each rack of BTS 107 for allocating a call to a radio resource. A message of allocation response 206 is referred to as RADIO LINK SETUP RESPONSE in 3GPP TS 25. 433 Ver6. 0. 0.

In a W-CDMA-compatible system, RADIO LINK ADDITION SETUP REQUEST and RADIO LINK ADDITION SETUP RESPONSE as defined in 3GPP TS 25. 433 Ver6. 0. 0 may be used instead in the message of allocation request and allocation response.

As described in the above, radio network controller 100 starts the operation of allocating a call to BTS at the moment when BTS is started.

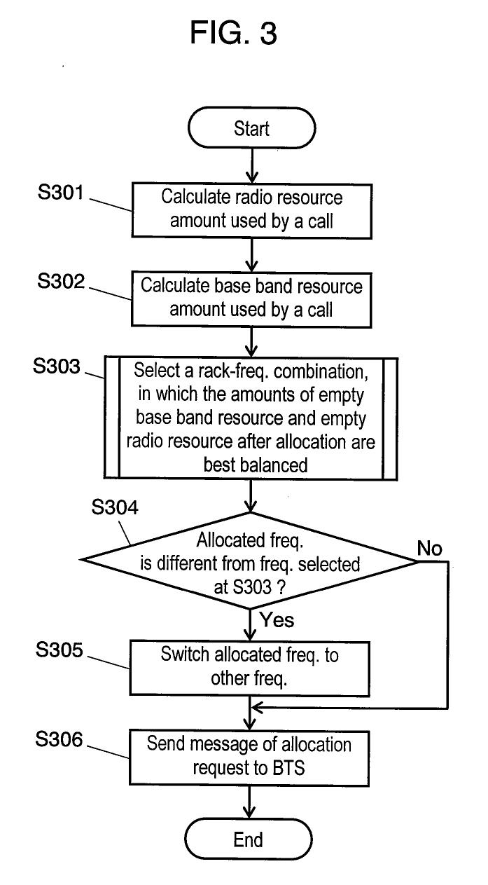

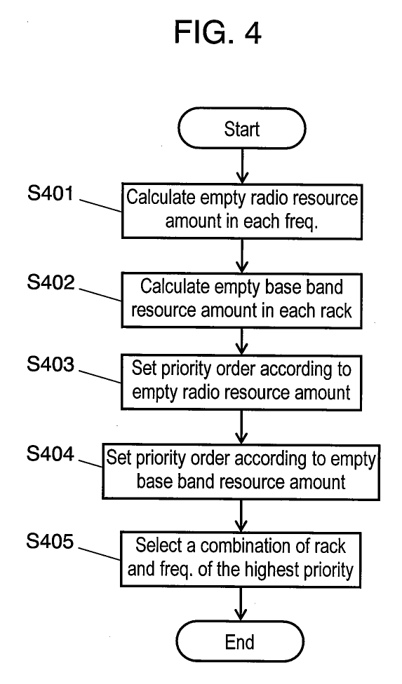

Now, the operation of radio network controller is described in accordance with the present embodiment, referring to the flow charts FIG. 3 and FIG. 4. The operation is conducted in the incoming sequence of calls.

Control means 106 calculates an amount of radio resource used at a certain frequency allocated to the call (Step S301). The amount of radio resource used may be calculated using either a known algorithm disclosed in Japanese translation of PCT publication No. 2003-524335, or other known algorithms. The terminology, amount of resource used, means a processing capacity required by a call.

Then, control means 106 calculates an amount of base band resource used at a certain allocated frequency (S302). The amount of base band resource used has already been decided by the type of a call, as described earlier in the background art.

At step S303, control means 106 selects a rack-frequency combination of best balance, based on the empty base band resource amount available and the empty radio resource amount available after deducting the amounts of resources used (as calculated at S301 and S302). The best balanced rack-frequency combination means a combination in which the empty resource amount available becomes the greatest at both of the base band resource and the radio resource. Here, the rack is ranked in the order of greatness of empty resource amount available, while radio resource is ranked in the order of greatness of empty amount available at each frequency, and a certain combination in which a product of the radio resource ranking order by the rack ranking order makes the smallest is selected.

FIG. 4 is a flow chart which details step S303.

Referring to FIG. 4, radio resource administration means 105 calculates an empty radio resource amount of each of the selectable frequencies (S401).

Rack information administration means 101 calculates an empty base band resource amount of each rack constituting base band signal processing unit 111(S402).

Control means 106 ranks the empty radio resource amount in the order of greatness, and regards the order as priority order (S403).

Control means 106 ranks the empty base band resource amount in the order of greatness, and regards the order as priority order (S404).

Control means 106 selects a best balanced rack-frequency combination in which a product of the rack priority order by the frequency priority order makes the smallest (S405).

Now reference is made to FIG. 3, control means 106 compares (S304) the call frequency with a frequency selected at step S303. If the former frequency is different from the latter frequency (YES, at S304), the call frequency is switched to other frequency (S305), and transmits a message to BTS 107 requesting to allocate the new frequency to the selected rack. On the other hand, if the former frequency is not different from the latter frequency (NO, at S304), control means 106 does not switch the frequency to other frequency, and sends a message to BTS 107 requesting to allocate it to the selected rack (S306).

Now in the following, a method how radio network controller 100 in the present embodiment allocate a call to a certain frequency and to a certain rack of base band signal processing unit 111 is described using a practical example.

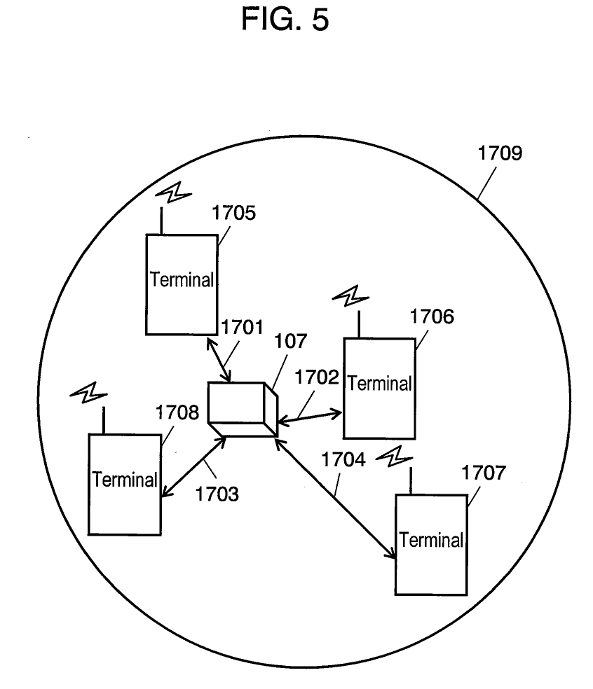

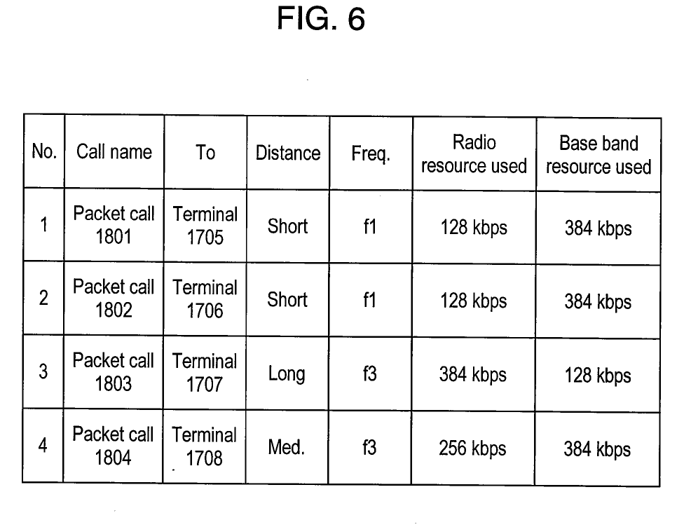

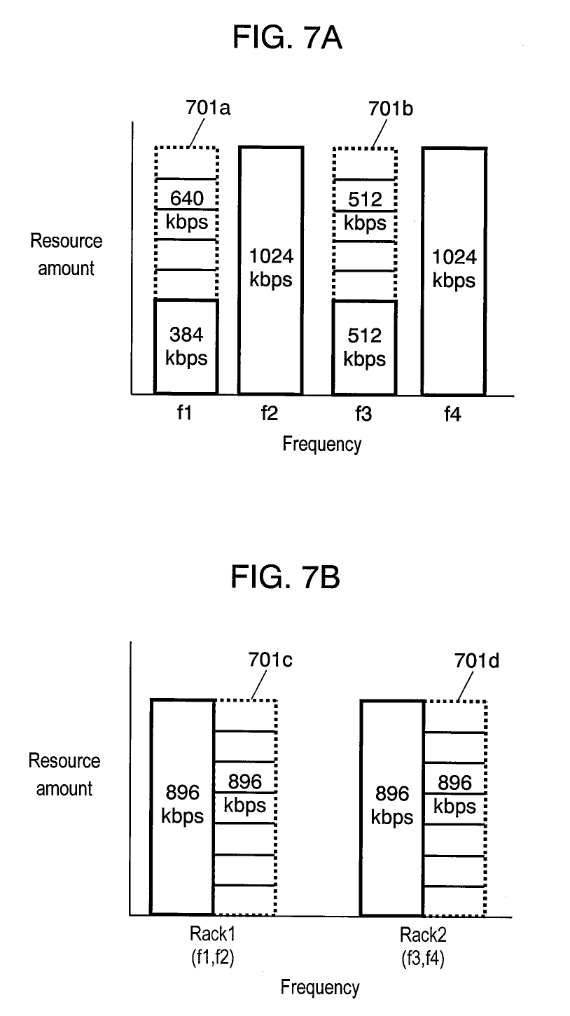

Suppose BTS 107 and the terminals 1705 through 1708 are in the position as shown in FIG. 5, or positioned the same as in the conventional example. The radio resource used between BTS 107 and the terminal, and the base band resource used in BTS 107 are as shown in FIGS. 7A and B, which being the same as in the conventional example. Packet calls to terminals 1705 through 1708 arise in the same manner as in the conventional example. FIG. 6 shows particulars of the packet calls.

In the first place, allocation of packet call 1801 is described with reference to flow charts, FIG. 3 and FIG. 4.

Radio resource amount used by the call is calculated (S301). It is 128 kbps, as shown in FIG. 6. The radio resource amount used may be calculated using the algorithm disclosed in Japanese translation of PCT publication No. 2003-524335, or other known algorithms.

Base band resource amount used by the call is calculated (S302). It is 384 kbps, as shown in FIG. 6.

Control means 106 selects a rack-frequency combination, in which there is a best balance between the position of empty base band resource and the position of empty radio resource available after deduction of the resources used (S303).

FIG. 4 is a chart which details step S303.

Referring to FIG. 4, an empty radio resource amount is calculated in each frequency (S401). As shown in FIG. 7A, the empty radio resource amount at frequency f1 is 640 kbps (701a), that at f2 is 0 kbps, at f3 is 512 kbps (701b), and at f4 is 0 kbps.

Rack information administration means 101 calculates the empty base band resource amount of each rack (S402). As shown in FIG. 7B, it is 896 kbps in rack 1 (701c), 896 kbps in rack 2 (701d), either.

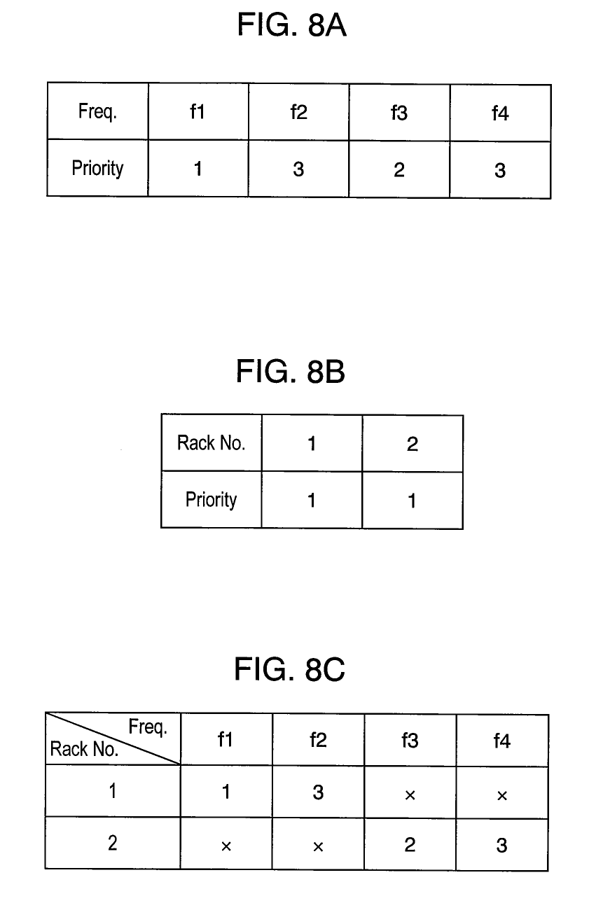

The empty radio resource amount is ranked in the order of greatness, and the order is regarded as priority order (S403). Here, the great empty resource amount is given a priority 1, while the small empty resource amount is given a priority 3. FIG. 8A shows the priority orders given to respective frequencies in accordance with the amount of empty radio resource.

Then, the empty base band resource amount is ranked in the order of greatness, and regards the order as priority order (S404). FIG. 8B shows the priority orders given in the same manner as in S403.

Next, a rack-frequency combination is selected, in which a multiplication of the rack priority by the frequency priority makes the smallest number (S405). FIG. 8C shows results of multiplication of the rack priority by the frequency priority set at S403 and S404. Because each of the racks has its own limit in the receivable number of frequencies, some of the combinations becomes a combination that can not be implemented; such combination is denoted with a symbol x. From FIG. 8C, a combination of rack 1 and frequency f1 is selected as the best balanced rack-frequency combination.

At S304 in FIG. 3, the call frequency is compared with a frequency selected at S405. The frequency of call 1801 is f1, the frequency selected at S405 is also f1 (NO, at S304); so, a message is transmitted to BTS 107 requesting to allocate it to rack 1 (S306).

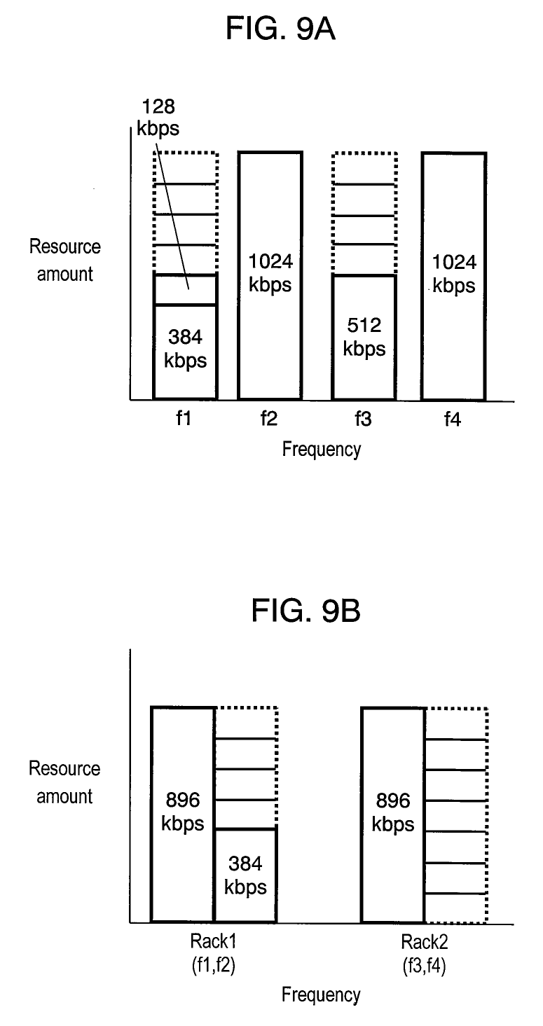

The position of radio resource and the base band resource used in BTS 107 after the allocation is as shown in FIGS. 9A and B.

Now, description is made on allocation of packet call 1802 incoming to terminal 1706 (No. 2 in FIG. 6).

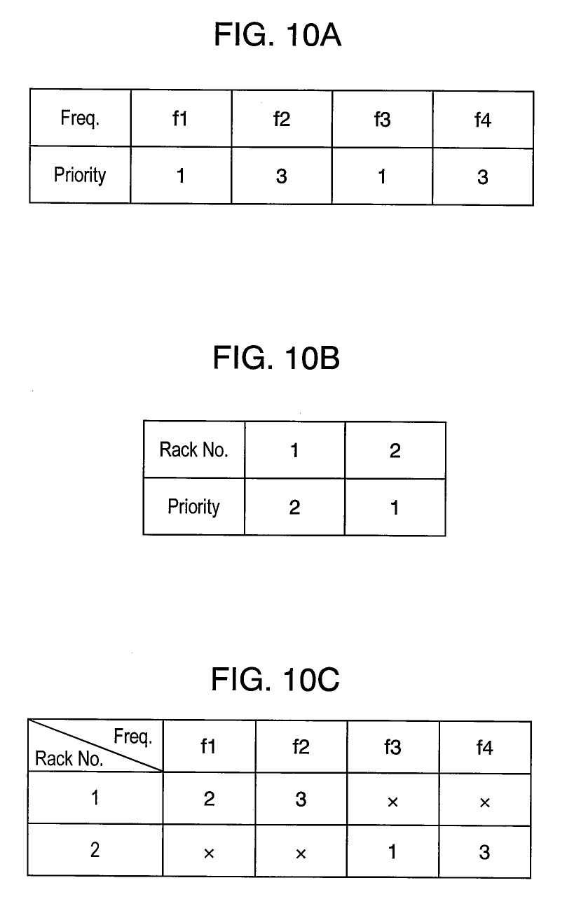

After it is processed in the same way as packet call 1801, position of the empty radio resource amount in each frequency (ref. S403 in FIG. 4) is as shown in FIG. 10A.

Position of the empty base band resource amount in each rack (ref. S404) becomes as shown in FIG. 10B. Result of the multiplication of the frequency priority by the rack priority conducted at S405 is as shown in FIG. 10C. Namely, the best balanced rack-frequency combination selected at step S405 is the combination of rack 2 and frequency 3. This case corresponds to a case of YES at S304, where the frequency of call 1802 is different from that given at S405. Therefore, the call frequency is switched from f1 to f3 (S305).

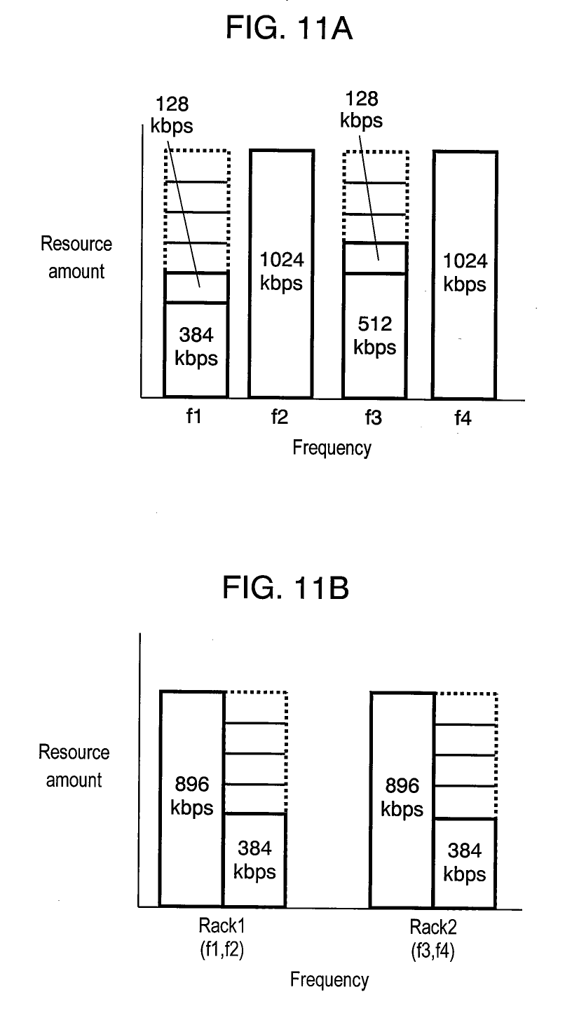

After the allocation of packet call 1802 to frequency and rack, the position of radio resource and base band resource used becomes as shown in FIGS. 11A and B.

Next, allocation of packet call 1803 (No. 3 in FIG. 6) is described.

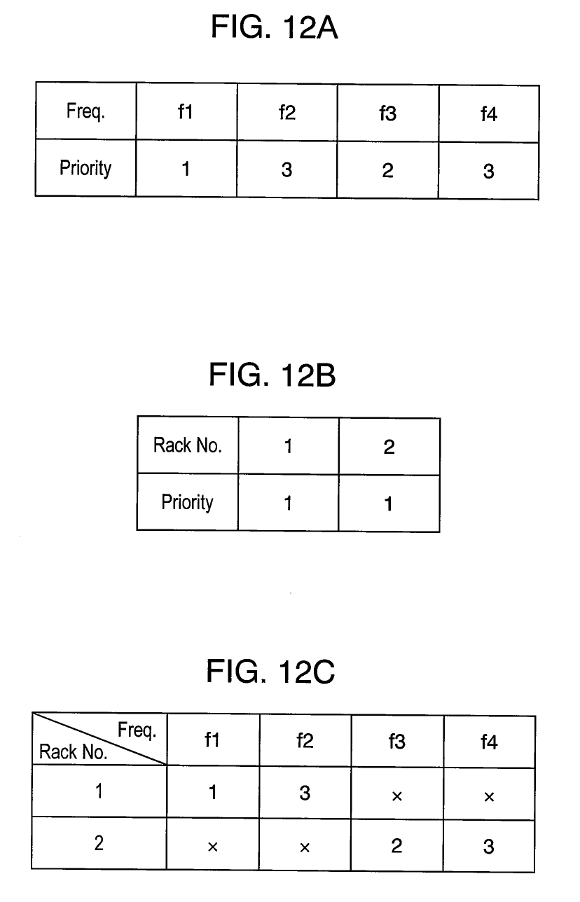

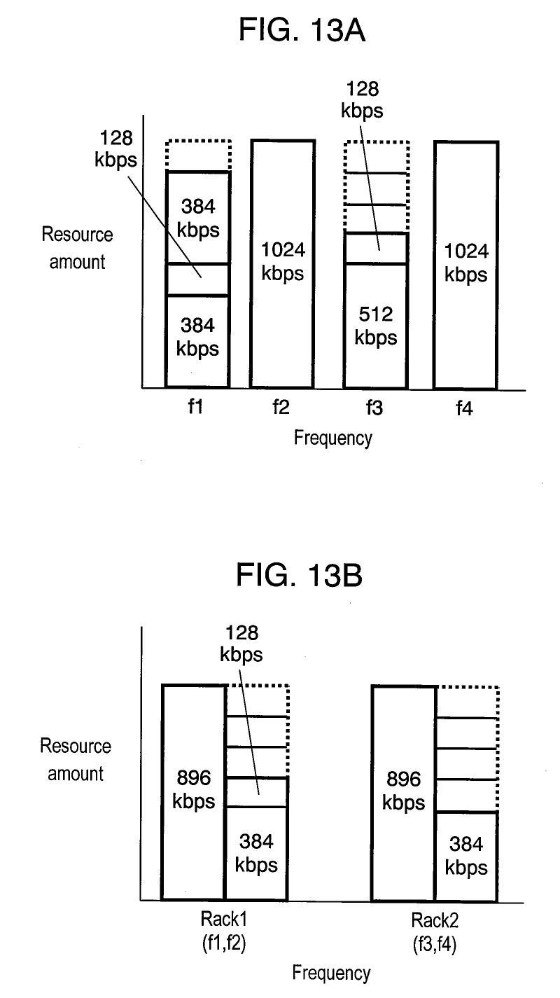

Packet call 1803 undergoes the same processing as packet calls 1801 and 1802. Position of the empty radio resource amount in each frequency (ref. S403 in FIG. 4) becomes as shown in FIG. 12A. Position of the empty base band resource amount in each rack (ref. S404) becomes as shown in FIG. 12B. Result of the multiplication of the frequency priority by the rack priority conducted at S405 is as shown in FIG. 12C. Therefore, the best balanced rack-frequency combination selected at step S405 is the combination of rack 1 and frequency f1. After packet call 1803 is allocated, the position of radio resource and base band resource used becomes as shown in FIGS. 13A and B.

Next, allocation of packet call 1804 (No. 4 in FIG. 6) is described.

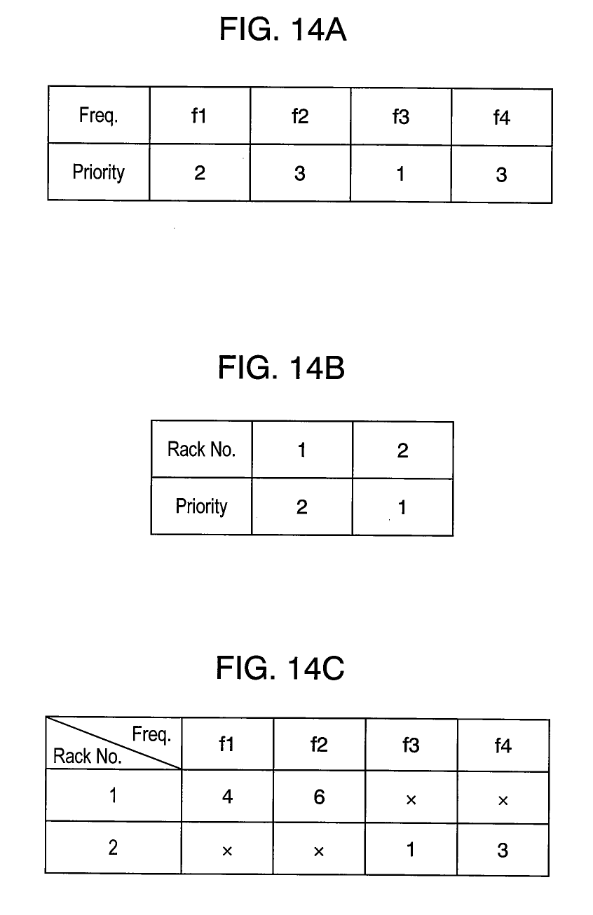

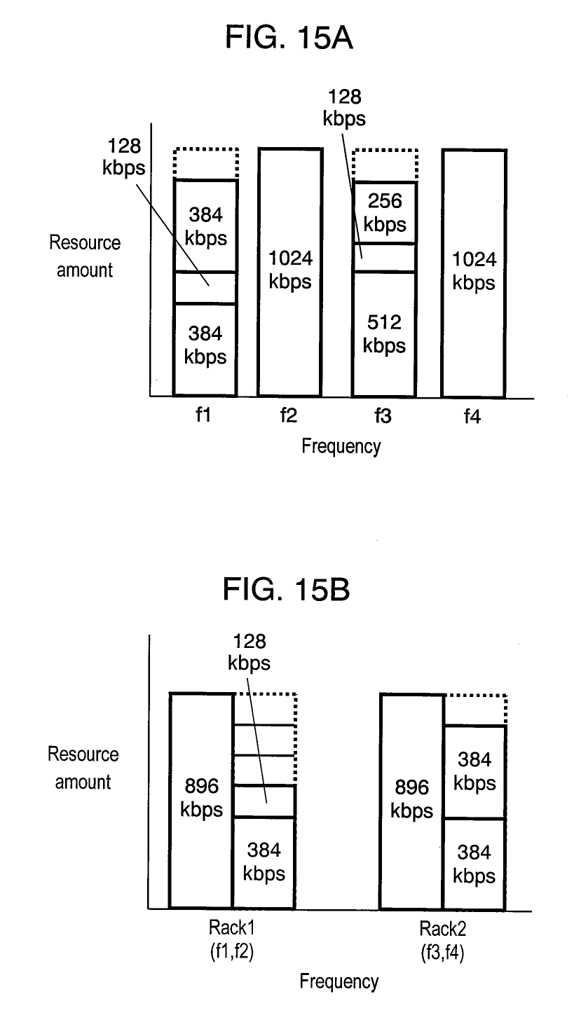

Packet call 1804 undergoes the same processing as packet calls 1801-1803. Position of the empty radio resource amount in each frequency (ref. S403 in FIG. 4) becomes as shown in FIG. 14A. Position of the empty base band resource amount in each rack (ref. S404) becomes as shown in FIG. 14B. Result of multiplication of the frequency priority by the rack priority conducted at S405 is as shown in FIG. 14C. Therefore, the best balanced rack-frequency combination selected at S405 is the combination of rack 2 and frequency f3. After allocation of packet call 1804, the position of radio resource and base band resource used becomes as shown in FIGS. 15A and B.

Thus, packet call 1804 which used to be rendered into a loss call can be allocated as a call in accordance with the present invention, instead of rendering into a loss call.

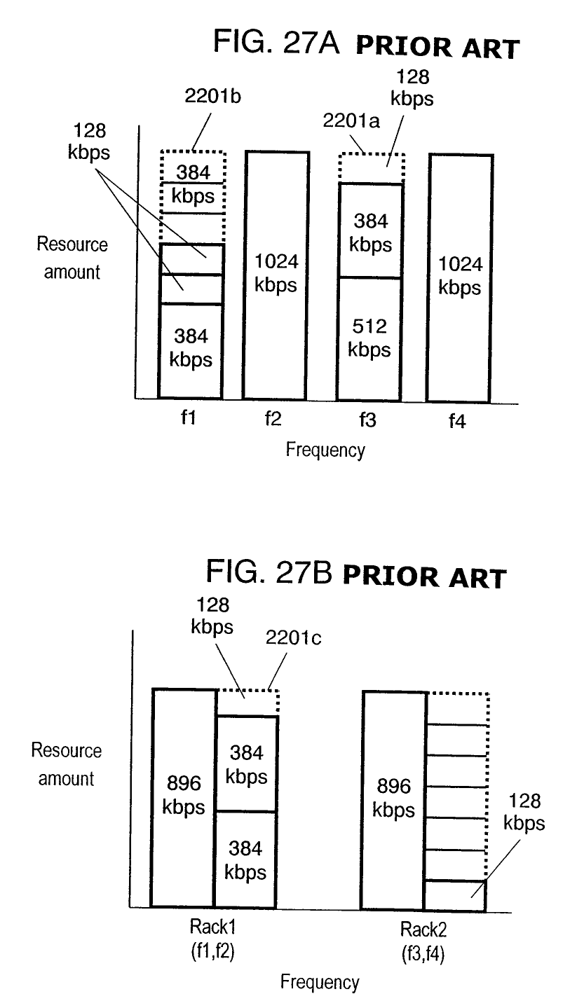

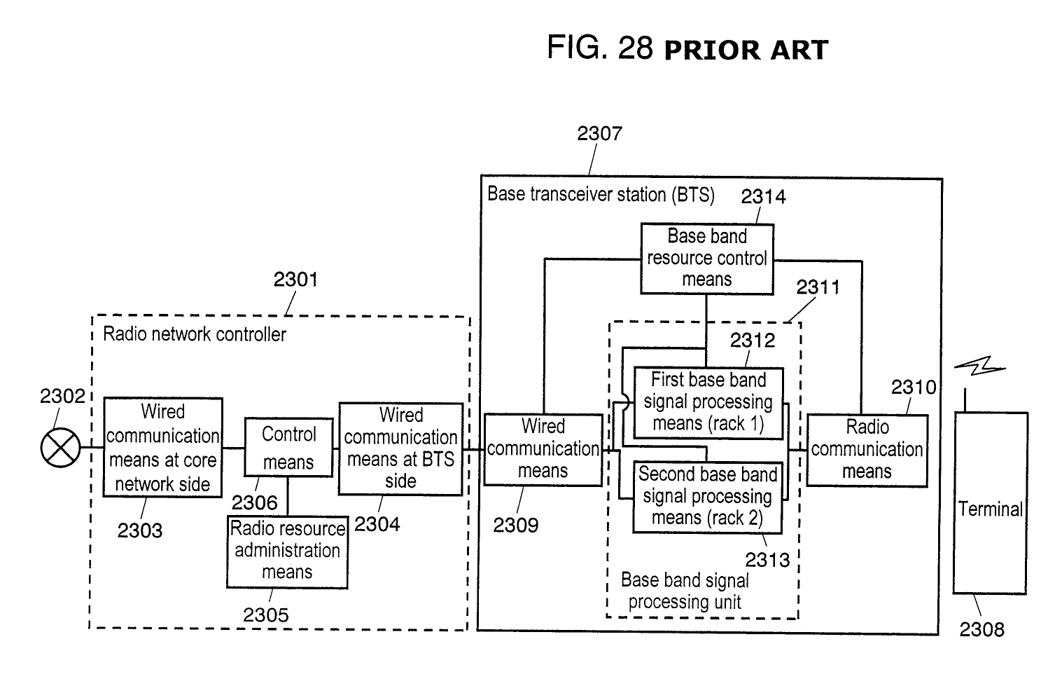

In a conventional method, a call allocation was conducted looking into an empty radio resource amount alone, without taking an empty base band resource amount into consideration. As the result, a call was treated as a loss call when the amount of empty base band resource was insufficient, despite there is a sufficient amount of empty radio resource, as shown in FIG. 27A. Or, insufficiency in the amount of empty radio resource resulted in a loss call in a conventional method, despite there is a sufficient empty amount with base band resource.

However, in radio network controller 100 in accordance with the present embodiment, the call allocation is conducted keeping a balance between the empty radio resource amount and the empty base band resource amount. As the result, a percentage of loss calls is reduced to be lower than that by a conventional controller.

Although the present embodiment has specified, at initialization processing response 203, a number of frequency kinds can be controlled in each rack; instead, one or more number of frequency kinds (f1-f4) that can be housed in each rack may be specified. In this case, at the resource allocation by radio network controller, a call is allocated to a rack which bears the same frequency kind as the call.

Although descriptions in the present embodiment have been based on a W-CDMA communication system, the present invention can of course be embodied in those communication systems other than the W-CDMA.

Besides the cases of emergence of new calls or hand-over operation, the present invention can be embodied also for such other case where, for example, a state of the call housed in a BTS or a radio network controller changes.

Furthermore, the present invention may be embodied in such a configuration where the base band signal processing means is consisting not of a rack, but of a high density card, IC, etc.

Although a rack-frequency combination in which a product of the order according to empty rack resource amount by the order of empty radio resource amount at each frequency makes the smallest has been described as the best balanced combination in the present embodiment, it is not limited to this type of combination. When a greater priority number is regarded to bear a higher priority, a combination in which a product of such priority numbers makes the greatest may be considered as the best balanced.

Although the radio resource has been described in the same manner as the base band resource using a processing speed (kbps) for the unit, it may be described using an electric power unit (W or W/Hz).

### Second Exemplary Embodiment

The point of difference as compared with the first embodiment is in the method of determining allocation of a call to a radio resource and to a rack which forms the base band resource of BTS. In the present second embodiment, it selects a rack-frequency combination in which a product of the ratio of an empty radio resource amount to the maximum radio resource processing capacity in each carrier wave frequency by the ratio of an empty base band resource amount to the greatest base band resource amount in each rack makes the greatest.

In a second embodiment, the same communication system (FIG. 1), the same procedures from the moment of start of a BTS until a call is allocated to the BTS (FIG. 2A), and the same processing at radio network controller (FIG. 3) as in the first embodiment are used.

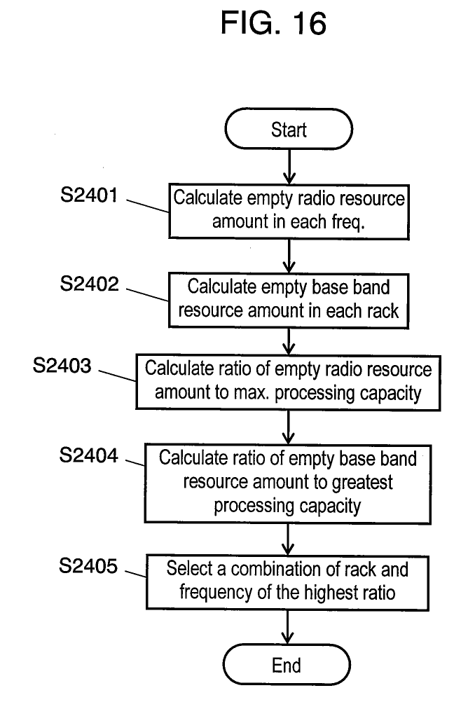

A method of determining an allocation of a call to a radio resource and to a rack in accordance with the second embodiment is described referring to FIG. 16. As compared with the method of first embodiment shown in FIG. 4, the present method uses a ratio of an empty radio resource amount to the maximum radio resource processing capacity in each carrier wave frequency, and a ratio of an empty base band resource amount to the greatest base band resource amount.

FIG. 16 is a flow chart which details step S303 of FIG. 3.

Reference is made to FIG. 16; radio resource administration means 105 calculates an empty radio resource amount of each frequency (S2401).

Rack information administration means 101 calculates an empty base band resource amount of each rack (S2402).

A ratio of the empty radio resource amount to the maximum radio resource amount is calculated (S2403).

A ratio of the empty base band resource amount to the greatest base band resource amount is calculated (S2404).

A rack-frequency combination in which a product of the ratio of empty radio resource amount in each carrier wave frequency by the ratio of empty base band resource amount in each rack makes the greatest is selected as the best balanced combination (S2405).

Now, a method how radio network controller 100 in the present embodiment allocates a call to a certain frequency and to a certain rack of base band signal processing unit 111 is described using a practical example.

Suppose BTS 107 and the terminals 1705 through 1708 are locating in the same manner as in the first embodiment, FIG. 5; and the state of radio resource used between BTS 107 and the terminal, and the base band resource used in BTS 107 also remain the same as in the first embodiment, FIGS. 7A and B. Packet calls arise to terminals 1705 through 1708 in the same manner as in the first embodiment. Particulars of the packet calls also remain the same as those in the first embodiment.

In the first place, allocation of packet call 1801 is described referring to the flow charts, FIG. 3 and FIG. 4.

At step S301, amount of radio resource used in an allocated call is calculated. It is 128 kbps, as shown in FIG. 6 at No. 1.

Amount of base band resource used in the call is calculated (S302). It is 384 kbps, as shown in FIG. 6 at No. 1.

A rack-frequency combination in which an empty base band resource amount and an empty radio resource amount after the allocation are in the best balanced position is selected (S303).

At step S2401 in FIG. 16, an empty radio resource amount is calculated in each frequency. As shown in FIG. 7A, the amounts are: 640 kbps at f1 (701a), 0 kbps at f2, 512 kbps at f3 (701b), and 0 kbps at f4.

At step S2402, rack information administration means 101 calculates an empty base band resource amount of each rack. It is 896 kbps in rack 1 (701c), 896 kbps in rack 2 (701d).

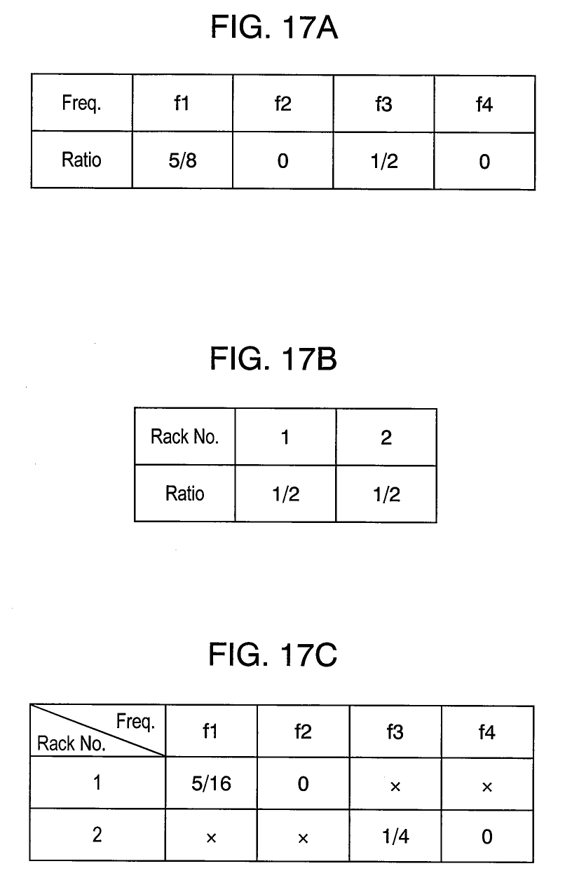

At step S2403, radio resource administration means 105 calculates a ratio of empty radio resource amount to the maximum radio resource amount. FIG. 17A shows the ratio of empty radio resource to maximum radio resource in each frequency.

At step S2404, rack information administration means 101 calculates a ratio of empty base band resource amount to the greatest base band resource amount. FIG. 17B shows the ratio of empty base band resource to the greatest band resource amount.

And then, at step S2405, control means 106 selects a rack-frequency combination in which a multiplication of the ratio of empty base band resource amount to the greatest base band resource amount calculated at S2404 in each rack and the ratio of empty radio resource amount to the maximum radio resource amount calculated at S2403 in each frequency makes the greatest as the best balanced combination. FIG. 17C shows the multiplied values calculated at steps S2403-S2404. Because each rack has its own limitation in the number of receivable frequencies, those impracticable combinations are denoted with a symbol x. From FIG. 17C, control means 106 selects a combination of rack 1 and frequency 1 as the most balanced one.

Then, at step S304 in FIG. 3, control means 106 compares the call frequency allocated with the frequency selected. Frequency f1 allocated to the call is identical to frequency f1 selected; so, a message is transmitted to BTS requesting to allocate it to rack 1 (S306).

Position of the radio and the base band resources used, after the allocation in BTS, is as shown in FIGS. 9A and B.

Next, allocation of packet call 1802 (No. 2 in FIG. 6) incoming to terminal 1706 is described.

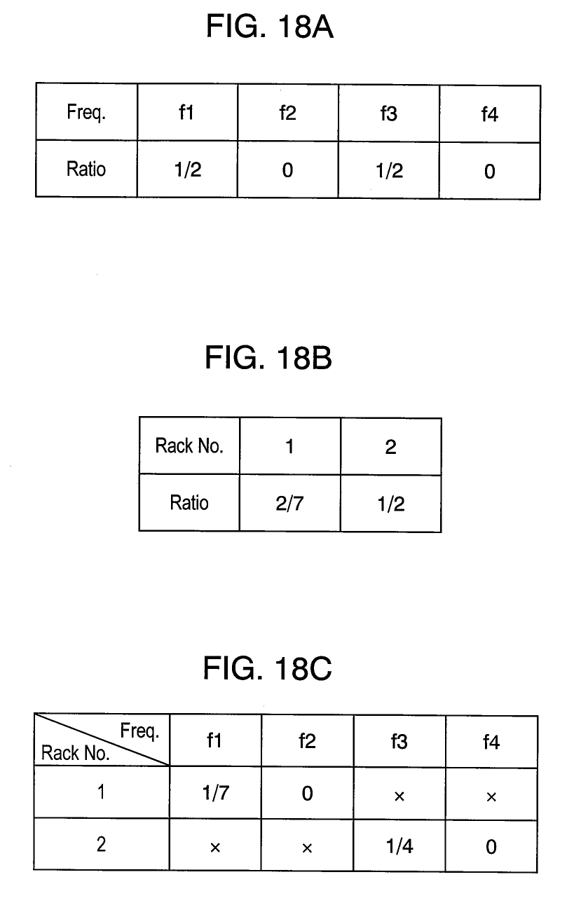

In the same way as in the allocation of packet call 1801, a ratio of the empty radio resource amount to the maximum radio resource amount in each frequency is calculated at step S2403 of FIG. 16. FIG. 18A shows the ratio of empty radio resource amount to maximum radio resource amount. In the same way, a ratio of empty base band resource amount to the greatest base band resource amount in each rack is calculated at S2404. FIG. 18B shows the ratio of empty base band resource amount to greatest band resource amount. At step S2405, the values calculated at S2403-S2404 are multiplied. FIG. 18C shows product of the two ratio values. So, at step S2405, control means 106 selects a combination of rack 2 and frequency f3.

And then, at S304 in FIG. 3, control means 106 compares the call frequency allocated with the selected frequency. Frequency f1 allocated is different from the selected frequency f3; so, control means 106 switches the frequency from f1 to f2 (S305).

Position of the radio resource and base band resource used, after packet call 1802 was allocated, is as shown in FIGS. 11A and B.

As described in the above, while a resource control system in a conventional technology selected rack 1 and frequency f1 as the place of allocation, control means 106 of a resource control system in accordance with the present embodiment selects rack 2 and frequency f3 as the most balanced combination of radio resource and base band resource.

Next, allocation of packet call 1803 (No. 3 in FIG. 6) is described.

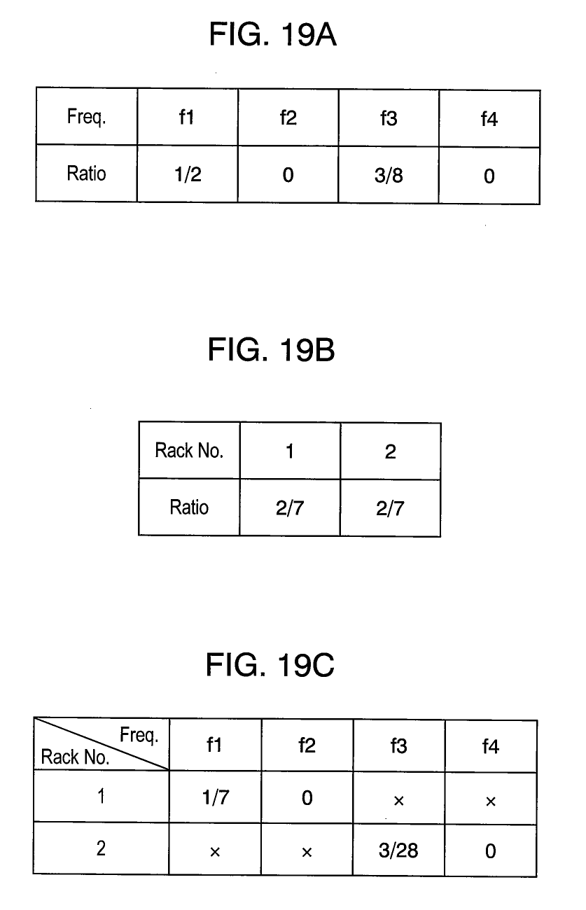

Packet call 1803 is allocated in the same way as packet calls 1801 and 1802. At step S2403 of FIG. 16, the ratio of empty radio resource amount to the maximum radio resource amount in each frequency is as shown in FIG. 19A. At step S2404, the ratio of empty base band resource amount to the greatest base band resource amount in each rack is as shown in FIG. 19B. At step S 2405, the product of the ratios calculated at S2403 and S2404 is as shown in FIG. 19C. So, a combination selected at S2405 is rack 1 and frequency f1.

Position of the radio resource and the base band resource used, after packet call 1803 was allocated, is as shown in FIGS. 13A and B.

Next, allocation of packet call 1804 (No. 4 in FIG. 6) is described.

Packet call 1804 is allocated in the same manner as packet calls 1801-1803.

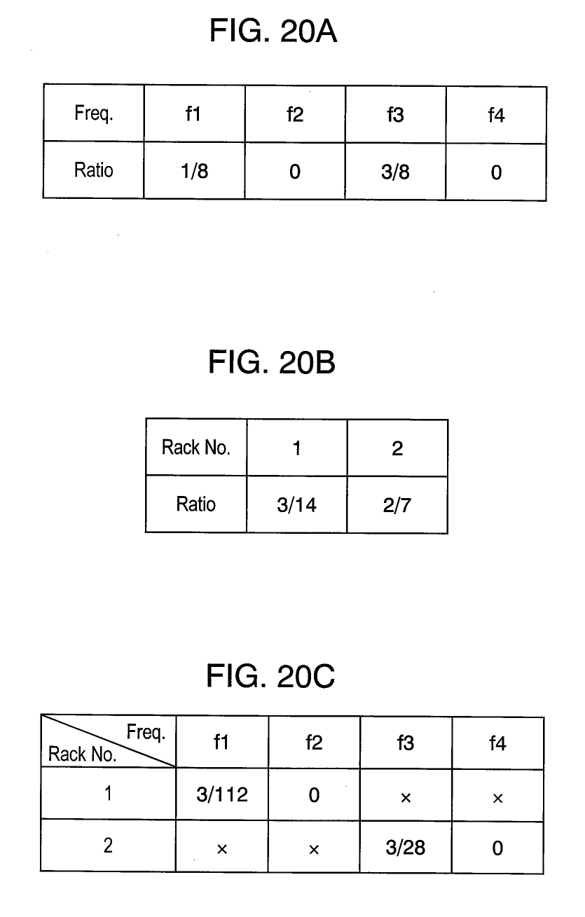

Ratio of an empty resource amount to the maximum radio resource amount calculated in each frequency at step S2403 of FIG. 16 is shown in FIG. 20A. Ratio of an empty resource amount to the greatest processing capacity of base band resource calculated in each rack at S2404 is as shown in FIG. 20B. Product of the ratio provided at S2403 by the ratio provided at S2404, which calculation is conducted at S2405, is as shown in FIG. 20C. So, a combination selected at S2405 of FIG. 16 is rack 2 and frequency f3.

Position of the radio resource used and the base band resource used, after the allocation of packet call 1804, is as shown in FIGS. 15A and B.

As described in the above, packet call 1804 was rendered into a loss call in a conventional technology. However, the same call can be allocated as a call, not a loss call, in a resource control system in accordance with the present embodiment.

Radio network controller 100 in accordance with the present embodiment allocates a call, in the same manner as in the first embodiment, keeping a balance between an empty radio resource amount and an empty base band resource amount. Therefore, a percentage of loss calls can be reduced to be lower than that occurred in a conventional technology.

The same advantages as described in the first embodiment can be implemented also in the present second embodiment.

### INDUSTRIAL APPLICABILITY

The present invention can be embodied in radio network controllers, methods of controlling radio networks and communication systems, and brings about an advantage of improving the efficiency of call allocation there.

1. A radio network controller comprising
a radio resource administration means for administrating a state of the use of radio resource, which being a resource that can be housed in a wireless region between a base transceiver station and a terminal,
a rack information administration means for administrating a state of the use of a plurality of racks, which being a resource constituting base band signal processing unit of the base transceiver station, and
a control means for selecting and deciding a call frequency used in the base transceiver station and allocating it to the rack of base band signal processing unit of base transceiver station taking into consideration a state of the use of radio resource and a state of the use of resource in the base band signal processing unit of base transceiver station.

2. The radio network controller of claim 1, wherein
the control means transmits a message to the base transceiver station requesting to allocate a call to a specified base band signal processing means of the base transceiver station.

3. The radio network controller of claim 1, wherein
the control means selects for the base transceiver station a combination of frequency and rack of the base band signal processing unit, in which combination both of an empty radio resource amount at each frequency and an empty resource amount in the base band signal processing unit at each rack are maximized keeping a good balance between the two empty resource amounts.

4. The radio network controller of claim 1, wherein
the control means selects for the base transceiver station a combination of frequency and rack of the base band signal processing unit, in which combination a multiplied value of the ratio of empty radio resource amount to the maximum processing capacity in each frequency and the ratio of empty resource amount to the greatest processing capacity in each rack of the base band signal processing unit makes the greatest.

5. The radio network controller of claim 1, wherein a state of the use of resource in the base band signal processing unit of base transceiver station means an information which contains;
a number of racks in the base band signal processing unit of base transceiver station,
a number of frequencies controllable in each rack of the base band signal processing unit of base transceiver station, and
the greatest resource amount in each rack of the base band signal processing unit of base transceiver station.

6. The radio network controller of claim 1, wherein a state of the use of resource in the base band signal processing unit of the base transceiver station means an information which contains;
a frequency which is set for each rack of the base band signal processing unit of base transceiver station, and
a remaining processing capacity in each rack of the base band signal processing unit of base transceiver station.

7. A communication system comprising
a radio network controller recited in claim 1, and
a base transceiver station which is wire-connected with the radio network controller and the base band resource is formed of a plurality of racks.

8. A control method of radio network for controlling an allocation of a call to a frequency used for communication between base transceiver station and terminal and an allocation to a base band resource of the base transceiver station, comprising the steps of
calculating, when a call arises, an amount of radio resource used in a frequency allocated to the call, which resource being a resource that can be housed in a radio region between radio transceiver station and terminal;
calculating an amount of base band resource used in a frequency allocated to the call;
calculating an empty radio resource amount available in each frequency by deducting the radio resource amount used from an empty radio resource amount at the time;
calculating an empty base band resource amount available in each rack, which rack forming the base band resource of base transceiver station connected with the radio network controller, by deducting the base band resource amount used from an empty base band resource amount at the time;
setting a priority order in accordance with the empty radio resource amount calculated for each frequency;
setting a priority order in accordance with the empty base band resource amount calculated for each rack, and
selecting a combination of frequency and rack in which a product of the priority order set in accordance with empty radio resource amount of each frequency by the priority order set in accordance with empty base band resource amount of each rack makes the greatest.

9. The control method of radio network recited in claim 8, comprising the steps of;
calculating a ratio of the empty radio resource amount to the maximum amount of radio resource between the base transceiver station and the terminal, instead of setting a priority order in accordance with empty radio resource amount calculated for each frequency;
calculating a ratio of the empty base band resource amount to the greatest base band resource amount of each rack of the base transceiver station, instead of setting a priority order in accordance with empty base band resource amount calculated for each rack; and
selecting a combination of the frequency and the rack, in which combination a product of the ratio of empty radio resource amount in each frequency by the ratio of empty base band resource amount in each rack makes the greatest, instead of selecting a combination of the frequency and the rack in which a product of the priority order of each frequency by the priority order of each rack makes the greatest.

10. The control method of radio network recited in claim 8, comprising the steps of
comparing a first frequency allocated to a call with a second frequency selected, and
in a case where the first frequency is not identical with the second frequency, transmitting a message to the base transceiver station requesting to switch the first frequency to the second frequency and allocating it to the selected rack;
in a case where the first frequency and the second frequency are identical, transmitting a message to the base transceiver station requesting only to allocate it to the selected rack.

11. A communication system comprising
a radio network controller recited in claim 2, and
a base transceiver station which is wire-connected with the radio network controller and the base band resource is formed of a plurality of racks.

12. A communication system comprising
a radio network controller recited in claim 3, and
a base transceiver station which is wire-connected with the radio network controller and the base band resource is formed of a plurality of racks.

13. A communication system comprising
a radio network controller recited in claim 4, and
a base transceiver station which is wire-connected with the radio network controller and the base band resource is formed of a plurality of racks.

14. A communication system comprising
a radio network controller recited in claim 5, and
a base transceiver station which is wire-connected with the radio network controller and the base band resource is formed of a plurality of racks.

15. A communication system comprising
a radio network controller recited in claim 6, and
a base transceiver station which is wire-connected with the radio network controller and the base band resource is formed of a plurality of racks.

16. The control method of radio network recited in claim 9, comprising the steps of
comparing a first frequency allocated to a call with a second frequency selected, and
in a case where the first frequency is not identical with the second frequency, transmitting a message to the base transceiver station requesting to switch the first frequency to the second frequency and allocating it to the selected rack;
in a case where the first frequency and the second frequency are identical, transmitting a message to the base transceiver station requesting only to allocate it to the selected rack.
